(19) United States
(12) Patent Application Publication
(10) Pub. No.: US 2010/0251132 A1
(43) Pub. Date: Sep. 30, 2010

(54) INFORMATION PROCESSING APPARATUS, IMAGE FORMING SYSTEM, AND RECORDING MEDIUM

(75) Inventor: Tetsuya Nishino, Osaka (JP)

Correspondence Address: MCDONNELL BOEHNEN HULBERT & BERGHOFF LLP, 300 S. WACKER DRIVE, 32ND FLOOR, CHICAGO, IL, 60606, US

(73) Assignee: Kyocera Mita Corporation, Osaka (JP)

(21) Appl. No.: 12/700,516

(22) Filed: Feb. 4, 2010

(30) Foreign Application Priority Data
Mar. 31, 2009 (JP) 2009-087902

(51) Int. Cl. H04L 9/32; G06F 3/048

(52) U.S. Cl. 715/743; 715/763

(57) ABSTRACT

An information processing apparatus includes a user authentication unit, a display-object-parts presenting section, a parts-selection-instruction accepting section, a layout-instruction accepting section, an action setting section, and a generating section. The user authentication unit permits an authenticated user to create screen data of a display screen. The display-object-parts presenting section presents display object parts to be displayed in the display screen. The parts-selection-instruction accepting section accepts, from the authenticated user, an instruction to select display object parts from the presented display object parts. The layout-instruction accepting section accepts an instruction to place the selected display object parts in the display screen from the authenticated user. The action setting section sets actions corresponding to indicated display object parts in association with the display object parts. The generating section generates the screen data on the basis of the instructions and the setting.

### INCORPORATION BY REFERENCE

This application is based upon and claims the benefit of priority from the corresponding Japanese Patent application No. 2009-87902, filed Mar. 31, 2009, the entire contents of which is incorporated herein by reference.

### FIELD OF THE INVENTION

The present invention relates to an information processing apparatus, an image forming system, and a recording medium, and in particular, to a technology for displaying a display screen desired by a user on the display of an image forming apparatus.

### BACKGROUND OF THE INVENTION

Electrical apparatuses, such as an image forming apparatus, that accept instructions from a user and perform operations indicated by the instructions have a display formed of an LCD (liquid crystal display) or the like on an operation panel at the front of the apparatus. Operation buttons displayed on the display using a touch panel function allow such electrical apparatuses to accept instructions to execute operations.

However, when displaying a plurality of transitory display screens on the display, the above image forming apparatus can only display screens whose display data is stored in the image forming apparatus. This is inconvenient because, in the case where the user wishes to customize a display screen by arranging customized operation buttons, etc. as desired, the image forming apparatus must store the display data of all display screens that the user customized. Furthermore, a technology for effectively managing permission for the user to customize the display screen is also required.

### SUMMARY OF THE INVENTION

An information processing apparatus configured to be connected to an image forming apparatus, according to a first aspect of the present invention, includes a user authentication unit, a display-object-parts presenting section, a parts-selection-instruction accepting section, a layout-instruction accepting section, an action setting section, and a generating section. The user authentication unit is configured to permit an authenticated user (who inputted identification information for authentication) to create screen data for a display screen to be displayed on a display of the image forming apparatus. The display-object-parts presenting section is configured to present display object parts to be displayed in the display screen. The parts-selection-instruction accepting section is configured to accept, from the authenticated user, a display-object-parts selection instruction to select display object parts from the display object parts presented by the display-object-parts presenting section. The layout-instruction accepting section is configured to accept from the authenticated user a layout instruction to place the selected display object parts in the display screen. The action setting section is configured to set actions corresponding to display object parts indicated by the display-object-parts selection instruction accepted by the parts-selection-instruction accepting section in association with the display object parts. Finally, the generating section is configured to generate the screen data of the display screen on the basis of the display-object-parts selection instruction, the layout instruction, and the setting by the action setting section.

An image forming system according to a second aspect of the present invention is an image forming system including an information processing apparatus and an image forming apparatus. The image forming apparatus includes a display. The information processing apparatus includes a user authentication unit, a display-object-parts presenting section, a parts-selection-instruction accepting section, a layout-instruction accepting section, an action setting section, and a generating section. The user authentication unit is configured to permit a user who inputted identification information, if the user is an authenticated user, to create screen data of a display screen to be displayed on the display of the image forming apparatus. The display-object-parts presenting section is configured to present display object parts to be displayed in the display screen. The parts-selection-instruction accepting section is configured to accept, from the authenticated user, a display-object-parts selection instruction to select display object parts from the display object parts presented by the display-object-parts presenting section. The layout-instruction accepting section is configured to accept a layout instruction from the authenticated user to place the selected display object parts in the display screen. The action setting section is configured to set actions corresponding to display object parts indicated by the display-object-parts selection instruction accepted by the parts-selection-instruction accepting section in association with the display object parts. Finally, the generating section is configured to generate the screen data of the display screen on the basis of the display-object-parts selection instruction, the layout instruction, and the setting by the action setting section.

According to a third aspect of the present invention is a method for customizing a display screen on an image forming apparatus. The method for customizing a display screen on an image forming apparatus includes steps of determining, permitting presenting, accepting a display-object-parts selection instruction, accepting a layout instruction, setting, and generating. The step of determining determines whether a user is authenticated based on identification information inputted by the user through an input device associated with a computer connected through a network to the image forming apparatus. The step of permitting, upon determining that the user is an authenticated user, permits the user to create screen data of a display screen to be displayed on a display of the image forming apparatus. The step of presenting presents display object parts to be displayed in the display screen. The step of accepting a display-object-parts selection instruction accepts, from the authenticated user, a display-object-parts selection instruction to select display object parts from the presented display object parts. The step of accepting a layout instruction accepts, from the authenticated user, a layout instruction to place the selected display object parts in the display screen. The step of setting sets actions corresponding to accepted display object parts. Finally, the step of generating generates the screen data of the display screen on the basis of the display-object-parts selection instruction, the layout instruction, and the action setting.

The various features of novelty which characterize the invention are pointed out in particularity in the claims annexed to and forming a part of this disclosure. For a better understanding of the invention, its operating advantages and specific objects attained by its uses, reference is made to the accompanying descriptive matter in which exemplary embodiments of the invention are illustrated in the accompanying drawings in which corresponding components are identified by the same reference numerals.

### BRIEF DESCRIPTION OF THE DRAWINGS

The following detailed description, given by way of example, but not intended to limit the invention solely to the specific embodiments described, may best be understood in conjunction with the accompanying drawings, in which:

FIG. 1 is a diagram showing an example of an image forming system according to an embodiment of the present invention;

FIG. 2 is a diagram showing the configurations of a server computer, a PC, and a multifunctional peripheral device according to an embodiment of the invention, necessary for generating and displaying a display screen;

FIG. 3 is a flowchart showing a display-screen generating process by a panel creator according to a first embodiment of the invention;

FIG. 4A is a diagram showing an example of a display screen displayed on a display according to an embodiment of the invention;

FIG. 4B is a diagram showing an example of a display screen displayed on the display according to an embodiment of the invention;

FIG. 4C is a diagram showing an example of a display screen generated in the generating process by the panel creator according to an embodiment of the invention;

FIG. 5 is a diagram showing an example of a customization acceptance screen according to an embodiment of the invention;

FIG. 6 is a flowchart showing a display-screen generating process by a panel creator according to a second embodiment of the invention;

FIG. 7 is a flowchart showing the process of displaying a display screen generated by the PC on the display of a multifunctional peripheral device and the process of accepting an operation execution instruction from the user in an image forming system according to an embodiment of the invention;

FIG. 8 is a diagram showing the configurations of a server computer, a PC, and a multifunctional peripheral device according to another embodiment, necessary for generating and displaying a display screen; and

FIG. 9 is a diagram showing the configurations of a server computer, a PC, and a multifunctional peripheral device according to yet another embodiment, necessary for generating and displaying a display screen.

### DETAILED DESCRIPTION OF THE EMBODIMENTS

Reference will now be made in detail to various embodiments of the invention, one or more examples of which are illustrated in the accompanying drawings. Each example is provided by way of explanation of the invention, and by no way limiting the present invention. In fact, it will be apparent to those skilled in the art that various modifications, combinations, additions, deletions and variations can be made in the present invention without departing from the scope or spirit of the present invention. For instance, features illustrated or described as part of one embodiment can be used in another embodiment to yield a still further embodiment. It is intended that the present invention covers such modifications, combinations, additions, deletions, applications and variations that come within the scope of the appended claims and their equivalents. Preferred embodiments of the INFORMATION PROCESSING APPARATUS, IMAGE FORMING SYSTEM, AND METHOD FOR CUSTOMIZING A DISPLAY SCREEN ON AN IMAGE FORMING APPARATUS of the present invention will now be described in detail according to constitutional features.

An image forming system, a server, and a computer-readable recording medium that stores a screen-data management program according to embodiments of the present invention will be described hereinbelow with reference to the drawings.

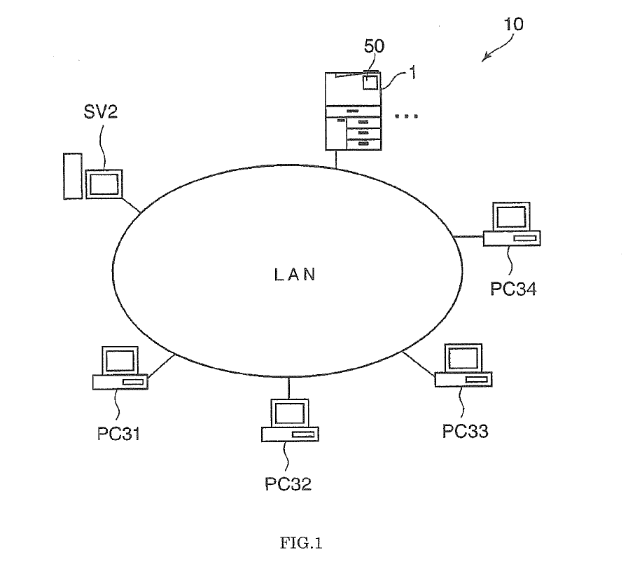

FIG. 1 is a diagram showing an example of an image forming system 10 according to an embodiment of the present invention. The image forming system 10 includes a plurality of multifunctional peripheral devices 1, a server computer SV2, and personal computers (hereinafter referred to as PCs) 31 to 34. However, the numbers of multifunctional peripheral devices, server computers, and PCs provided in the image forming system 10 are not limited thereto.

The multifunctional peripheral device 1, one example of an image forming apparatus, has a copy function, a facsimile function, a print function, a scan function, etc. Furthermore, the multifunctional peripheral device 1 has a document management function that involves storing the document data of an original read by a scanner unit in an internal storage unit of the multifunctional peripheral device 1 or in storage sections in the server computer SV2 and the PCs 31 to 34 that are connected to the multifunctional peripheral device 1 via a network, such as a LAN (local area network). The document management function then reads the print data stored in the internal storage unit of the multifunctional peripheral device 1 and the storage sections in the server computer SV2 and the PCs 31 to 34 and prints the data.

Furthermore, the multifunctional peripheral device 1 is equipped with a display 50 formed of an LCD (Liquid crystal display). The server computer SV2 can generate the screen data of a display screen (hereinafter referred to as screen data) displayed on the display 50 of the multifunctional peripheral device 1. The multifunctional peripheral device 1 receives the screen data from the server computer SV2 and the PCs 31 to 34 to display a display screen on the display 50 and displays the data on the display 50. The process of generating the screen data by the image forming system 10 and the configuration and process of the multifunctional peripheral device 1 for displaying the display screen will be described later.

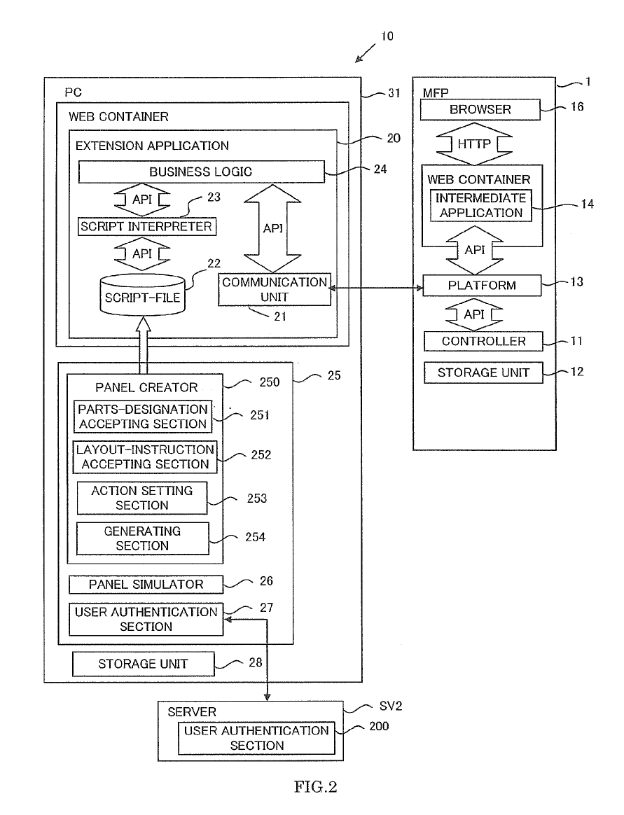

Next, the internal configurations of the server computer SV2, the PCs 31 to 34, and the multifunctional peripheral device 1 necessary for generating and displaying the screen data will be described. FIG. 2 is a diagram showing the configurations of the server computer SV2, the PC 31, and the multifunctional peripheral device 1 necessary for generating and displaying a display screen. Since the configurations of the server computer SV2 and the PCs 31 to 34 necessary for generating a display screen are the same, FIG. 2 shows the configuration of the PC 31. In this embodiment, it is sufficient that at least one of the server computer SV2 and the PCs 31 to 34 has the configuration below. That is, this embodiment will be described when applied to a case in which the PC 31 performs a display-screen generation process; however, the generation process may be performed by any of the other PCs 32 to 34 and the server computer SV2. In the case where the server computer SV2 performs the generation process, user authentication shown below is completed by the server computer SV2 itself or performed by accessing another server computer.

The PC 31 includes an extension application 20, a communication unit 21, a control unit 25, a script-file storage unit 22, and a storage unit 28.

The storage unit 28 is an HDD (hard disk drive) or the like, which stores a program for a panel creator 250 to generate a display screen displayed on the display 50 of the multifunctional peripheral device 1, a program for controlling the overall operation of the PC 31, a program for the extension application 20, etc.

The control unit 25 includes a CPU, which controls the overall operation of the PC 31 and functions as the panel creator 250, a panel simulator 26, and a user authentication section 27 by operating in accordance with the programs stored in the storage unit 28.

The panel creator 250 is a tool for generating the screen data of a display screen displayed on the display 50 of the multifunctional peripheral device 1 in, for example, an XML (extensible markup language) format.

The panel creator 250 accepts from the user customization of display object parts, such as buttons, that constitute the display screen and generates the display screen.

A parts-designation accepting section 251 receives instructions from the user via an operating device (a mouse, a keyboard, or the like) (not shown) on display object parts, such as operation buttons, icons, and character strings, to be displayed in the display screen. The instructions are provided at the PC 31 by the user. The image data of the display object parts that can be designated by the user is stored in the panel creator 250.

For example, when an instruction to generate a display screen is input by the user via the operating device, the parts-designation accepting section 251 causes a customization acceptance screen to be displayed for guiding the user in selecting display object parts. The customization acceptance screen is caused to appear on a display, such as an LCD, provided on the PC 31. This customization acceptance screen displays the display object parts. When a desired display object part is designated from the displayed display object parts by the user with the operating device, the parts-designation accepting section 251 accepts the designation of the display object part.

A layout-instruction accepting section 252 accepts from the user a layout instruction to place, in the display screen, display object parts designated with the parts-designation accepting section 251. For example, the layout-instruction accepting section 252 displays a shadow background image of the display screen on the display using the data of the background image of the display screen stored in the panel creator 250. When any places in the background image are designated by the user using the operating device, the layout-instruction accepting section 252 accepts the designated places as places for the designated display object parts.

An action setting section 253 sets the display object parts designated with the parts-designation accepting section 251 in association with actions corresponding to the display object parts. That is, with the parts-designation accepting section 251, the type of display object part placed in the display screen is designated by the user, while the action setting section 253 sets the designated display object part in association with an operation of the multifunctional peripheral device 1 corresponding to the display object part. For example, when a display object part, “Document size A3 button”, is designated by the user, the action setting section 253 sets in advance an appropriate action associated with “Document size A3 button”. Thus, “operation to accept an instruction to feed recording paper from a paper cassette in which A3-size recording paper is stored” is associated with the “Document size A3 button”.

A generating section 254 generates a display screen with details set in the designation of display object parts with the parts-designation accepting section 251, the layout instruction with the layout-instruction accepting section 252, and the action set in the action setting section 253. That is, with the designation of the display object part using the parts-designation accepting section 251 and the layout instruction using the layout-instruction accepting section 252, the user can customize a screen to be displayed on the display 50 of the multifunctional peripheral device 1 as desired by the action setting by the action setting section 253 and the display-screen generating process by the generating section 254. In this embodiment, the generating section 254 exports the screen data in the XML format to a script file. Although this embodiment uses the XML-format script file as a data file of the display screen, another markup language other than the XML format may be used in system configuration.

The panel simulator 26 is a tool for analyzing the description of screen data formed in the script file exported by the panel creator 250 on the PC 31, converting the screen data to HTML-format data to allow the screen data to be displayed on the display of the PC 31, and displaying the HTML-format display screen file as display data on a browser on the PC 31.

The user authentication section 27 accepts a request for permission to execute the display-screen generating process by the panel creator 250 from the user on the basis of input of, for example, user identification information by the user using an operating device (not shown) (in this embodiment, user ID and a password), and if the user is an authenticated user, the user authentication section 27 permits the user to perform the display-screen generating process.

When user identification information is input from the user via the operating device (not shown), the user authentication section 27 transmits the user identification information to the server computer SV2 connected to the PC 31 via a network. In the server computer SV2, a user authentication unit 200 determines whether user identification information (user ID and a password) registered in advance in the user authentication unit 200 matches the user identification information input from the user authentication section 27 of the PC 31. If the two pieces of user identification information match, the user authentication unit 200 of the server computer SV2 determines that the input user identification information (the user who holds the user identification information) is valid. The user authentication unit 200 returns the result of authentication of whether the input user identification information is valid to the user authentication section 27 of the PC 31.

The user authentication section 27 of the PC 31 determines whether to permit the user who inputted the user identification information to perform the display-screen generating process in accordance with the result of the authentication received from the user authentication unit 200 of the server computer SV2.

The PC 31 includes the extension application 20 as a necessary element as an embodiment of the present invention. The extension application 20 mainly includes the communication unit 21, the script-file storage unit 22, a script interpreter 23, and a business logic 24.

The extension application 20 is an application that can be additionally installed in the PC 31.

The communication unit 21 transmits and receives screen data stored in the script-file storage unit 22, control commands, button designation information, etc. to and from the multifunctional peripheral device 1.

The script-file storage unit 22 stores the script-file screen data generated by the panel creator 250.

The script interpreter (data conversion section) 23 analyzes screen data stored in the script-file storage unit 22 and performs a data conversion process of converting the screen data to a data format (in this embodiment, the HTML format) that can be displayed on the display 50 using a browser 16 of the multifunctional peripheral device 1. The script interpreter 23 also expands the screen data to the business logic 24 for executing actions associated with the display object parts, such as operation buttons, arranged in the display screen. The script interpreter 23 passes the data converted to the HTML format for display to the business logic 24 via an API (application programming interface).

The business logic 24 transmits the data converted to the HTML format for display to a platform 13 of the multifunctional peripheral device 1 via the communication unit 21. The business logic 24 also controls the action (i.e. operation) of the multifunctional peripheral device 1 on the basis of the information obtained by the script interpreter 23 in analyzing the script file (which includes information indicating display object parts and information indicating actions set for the display object parts).

That is, when a display object part, such as an operation button, displayed on the multifunctional peripheral device 1 is designated by the user with the browser 16 of the multifunctional peripheral device 1, the business logic 24 obtains button designation information indicating the designated display object part from the multifunctional peripheral device 1 via the communication unit 21. The business logic 24 further analyzes any actions set for the display object part indicated by the button designation information on the basis of the information passed from the script interpreter 23 and calls an API (control command) corresponding to the analyzed action to execute the analyzed action. That is, the business logic 24 generates a control command for the multifunctional peripheral device 1 to execute the analyzed action. For example, if the analyzed action is a scan function, the business logic 24 calls a scanner transmission API as a control command for the multifunctional peripheral device 1 to execute the scan function.

On the other hand, the multifunctional peripheral device 1 includes a controller 11, a storage unit 12, a platform 13, an intermediate application 14, and the browser 16.

The controller 11 controls the overall operation of the multifunctional peripheral device 1. The controller 11 is provided as firmware and executes the basic functions of the multifunctional peripheral device 1, such as transmission of scan data, printing, data access, system setting, network communication, job control, and data registration.

The platform 13 is a framework for APIs to operate on. The platform 13 is also charged with relaying between the controller 11 and the APIs.

Furthermore, the platform 13 obtains display data to be displayed on the display 50 (data converted to the HTML format by the script interpreter 23) and various instructions from the PC 31 via a LAN or the like.

The APIs are interfaces for executing the basic functions of the multifunctional peripheral device 1 executed by the controller 11 of the multifunctional peripheral device 1 without using the firmware. The APIs execute the basic functions of the multifunctional peripheral device 1 by accessing the controller 11 in the firmware of the multifunctional peripheral device 1 through the platform 13 of the multifunctional peripheral device 1.

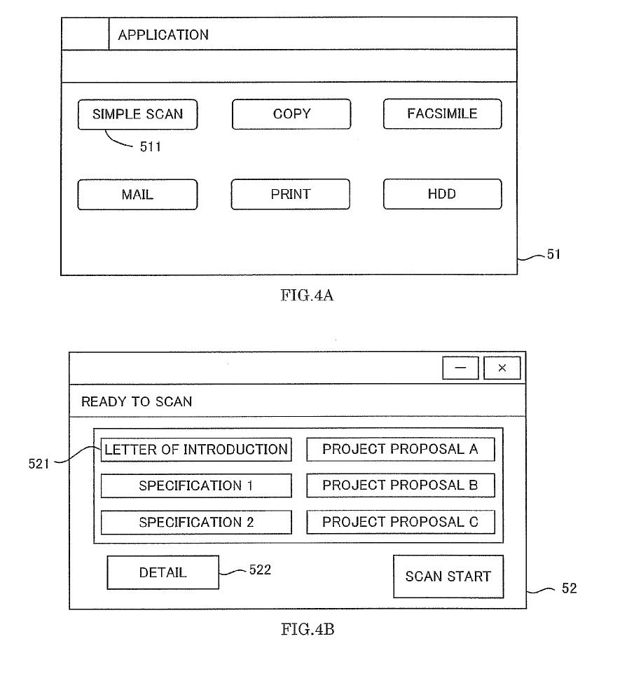

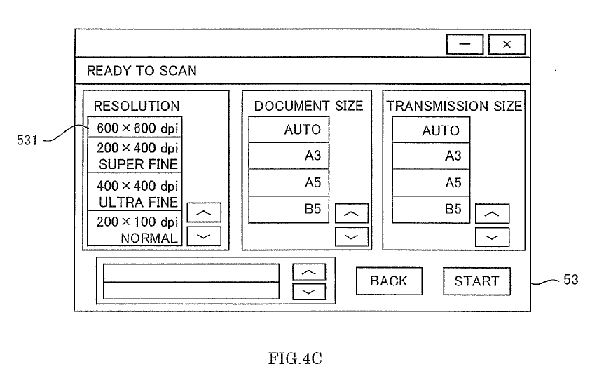

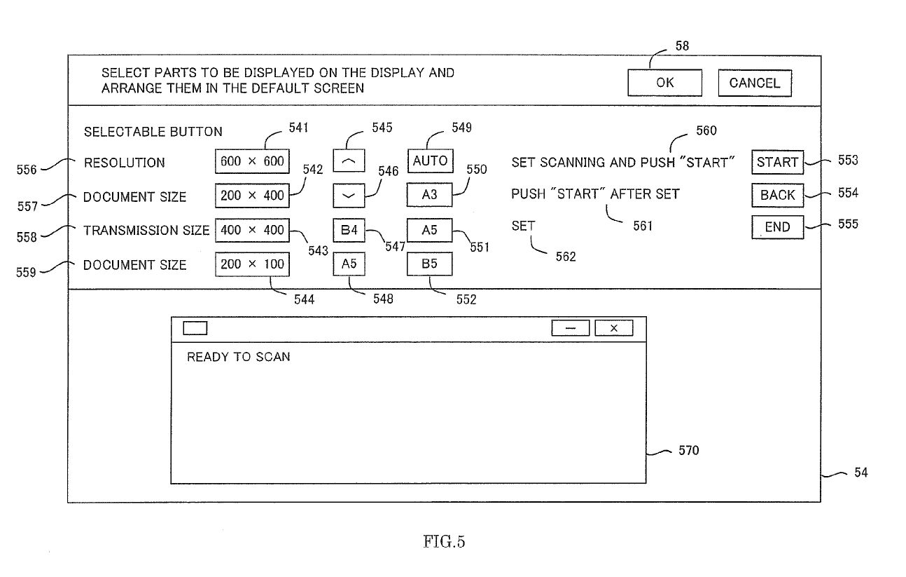

If the user depresses a “simple scan” button 511 on a touch panel while a display screen (for example, a first display screen 51 in FIG. 4A) is displayed on the display 50, the controller 11 makes an inquiry to the extension application 20 of the PC 31 via the platform 13. That is, the controller 11 sends button designation information (display-part designation information) indicating that the “simple scan” button 511 (an example of a display object part) is designated by the user to the extension application 20 of the PC 31 via the platform 13, and the extension application 20 analyzes an action set for the button indicated by the button designation information (that is, the “simple scan” button 511).

In a case where the button indicated by the button designation information is the “simple scan” button 511, as in this example, and the action analyzed by the extension application 20 is a transition of the display screen of the display 50 of the multifunctional peripheral device 1, the script interpreter 23 and the business logic 24 of the extension application 20 start analysis of the script-file screen data stored in the script-file storage unit 22. They convert the screen data into the HTML format to allow transition of the display screen of the display 50 of the multifunctional peripheral device 1 to, for example, a workflow selection screen 52 shown in FIG. 4B. The business logic 24 generates a control command for the multifunctional peripheral device 1 to execute the analyzed action, that is, the display screen transition.

The storage unit 12 is a HDD or the like, that stores an operation control program for operating the controller 11, a program for the browser 16, etc. The CPU, which is the central control unit of the multifunctional peripheral device 1, operates in accordance with the programs stored in the storage unit 12 so that the controller 11, the browser 16, etc. function.

The intermediate application 14 performs an intermediating process for allowing the HTML-converted display data that the platform 13 received from the PC 31 to be processed by the browser 16.

The browser 16 is a Web browser, which allows the HTML-converted display data obtained through the script interpreter 23 and the business logic 24 to be displayed on the display 50. In this embodiment, the browser 16 serves as an interface for displaying a display screen on the display 50 in accordance with a screen configuration indicated by the file converted to the HTML format by the extension application 20 and for accepting a user input operation via the touch panel function of the display 50 while the display screen is displayed.

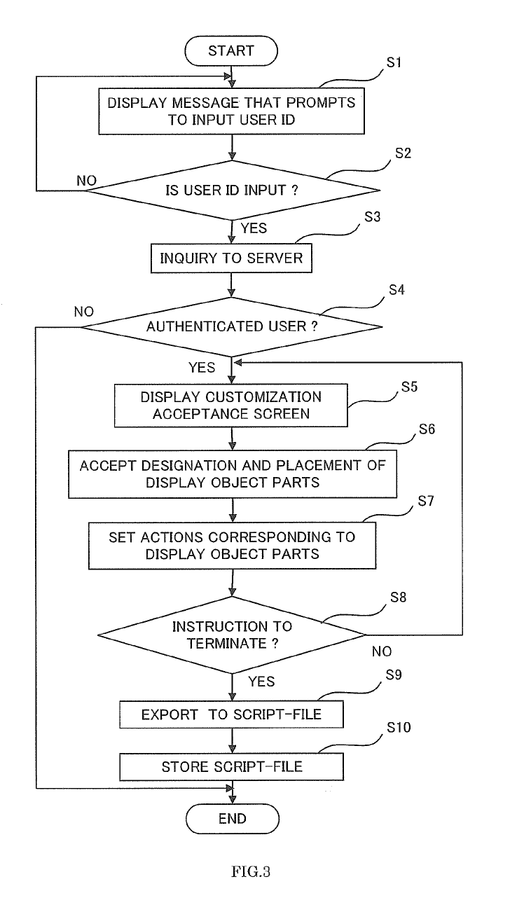

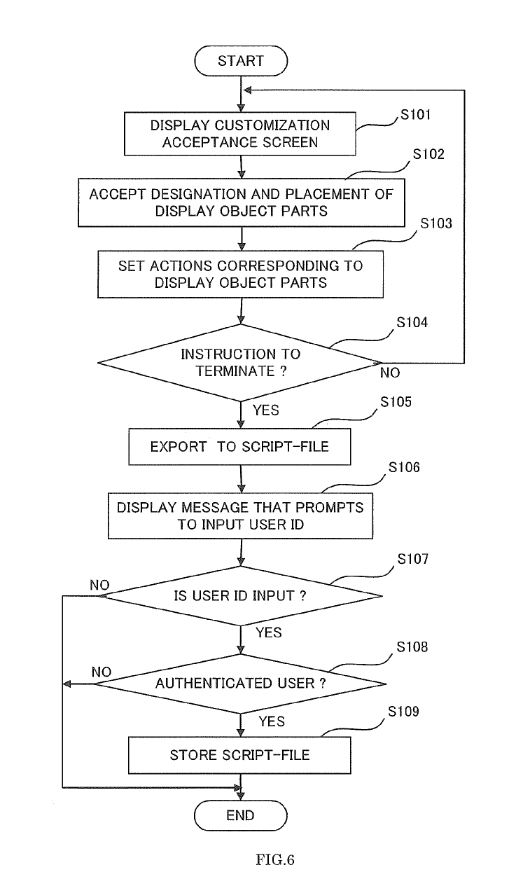

Next, the display-screen generating process of the panel creator 250 of the PC 31 will be described. FIG. 3 is a flowchart showing the display-screen generating process of the panel creator 250. FIGS. 4A and 4B are diagrams showing examples of the display screen displayed on the display 50. FIG. 4C is a diagram showing an example of the display screen generated in the generating process by the panel creator 250. FIG. 5 is a diagram showing an example of the customization acceptance screen.

For example, as shown in FIG. 4A, when the power of the multifunctional peripheral device 1 is turned on or when the user depresses an application key (for example, a hard key) (not shown) on the operation panel, the first display screen 51 is displayed on the display 50 under the display control with the browser 16. When the user depresses, for example, the “simple scan” button 511 on the first display screen 51, the controller 11 inquires of the extension application 20 (business logic 24) of the PC 31 about an operation control to be executed in response to the depressing operation. For example, if the extension application 20 determines that the operation control to be executed on the basis of the depressing operation is transition of the screen display to the workflow selection screen 52 shown in FIG. 4B, the extension application 20 performs a process for shifting the display of the display 50 to the workflow selection screen 52.

Furthermore, if the user selects a “letter of introduction” button 521 and depresses a “detail” button 522 on the workflow selection screen 52, the business logic 24 performs an analysis of operation control to be executed according to the depressing operation in response to the inquiry from the controller 11. Assuming that the business logic 24 analyzes that the operation control to be executed is transition of the screen display to a detail setting screen 53 (FIG. 4C) for setting a work flow corresponding to the “letter of introduction” button 521, the business logic 24 causes the browser 16 to shift the display of the display 50 to the detail setting screen 53.

For example, the extension application 20 (script interpreter 23 etc.) has a plurality of screen templates, button templates, and character string data of the display screen, as shown in FIG. 5. The extension application 20 analyzes the script file customized by the user, applies character strings to the screen and buttons, as in the detail setting screen 53 shown in FIG. 4C, using the data, such as screen templates, in accordance with the number or layout of keys to be displayed in a screen indicated by the script file, and causes the character strings to be displayed on the display 50 using the browser 16.

When the user inputs a display-screen generation instruction by operating the operating device (not shown) of the PC 31 to perform the display-screen generating process, the control unit 25 causes a message that prompts the user to input user identification information to appear on the display of the PC 31 (S1).

When user identification information is input by the user via the operating device in response to the message (S2: YES), the user authentication section 27 transmits the input user identification information to the server computer SV2 to inquire about whether the user who inputted the user identification information is an authorized user (S3).

Here, if it is determined by the user authentication unit 200 of the server computer SV2 that the user is not an authenticated user, and the user authentication section 27 of the PC 31 receives the result of the authentication from the server computer SV2 (S4: NO), the process is terminated without starting the display-screen generating process by the panel creator 250.

In contrast, if it is determined by the user authentication unit 200 of the server computer SV2 that the user is an authenticated user, and the user authentication section 27 of the PC 31 receives the result of the authentication from the server computer SV2 (S4: YES), the panel creator 250 is started, and the parts-designation accepting section 251 of the panel creator 250 causes, for example, a customization acceptance screen 54, as shown in FIG. 5, on the display of the PC 31 (S5).

In the customization acceptance screen 54, the user operates an operation-indication input device, such as a mouse, to indicate desired operation buttons or messages by selecting them from a plurality of operation buttons 541 to 555 or messages 556 to 562, which are displayed as selectable display object parts. Once the desired operation buttons or messages are selected, the parts-designation accepting section 251 accepts the selected operation button or messages as display object parts to be displayed on a display screen (that is, a display screen displayed on the display 50 of the multifunctional peripheral device 1 (S6)). Furthermore, when the user drags the selected operation buttons or messages to desired positions (by dragging and dropping) in a default screen 570 displayed on the customization acceptance screen 54, the layout instructions for placing the selected operation buttons, etc. in the positions are accepted by the layout-instruction accepting section 252 (S6).

When the designation of the display parts and the layout instructions are accepted by the layout-instruction accepting section 252, the action setting section 253 reads actions corresponding to the display object parts indicated by the accepted instructions (that is, instructions to execute the individual operations to be executed by the multifunctional peripheral device 1) from its internal storage region and sets the actions in association with the selected display object parts (S7).

For example, in a case where the user designates a resolution “600×600 dpi” button 541 at the designation of the display parts, the action setting section 253 assigns, for a scanning operation, the action of inputting an instruction to cause the scanner unit to read an original at a resolution of 600×600 dpi to the “600×600 dpi” button 541. Alternatively, in a case where the user designates a “Back” button 554 at the designation of the display parts, the action setting section 253 assigns an input of an instruction to shift the display of the display 50 to the workflow selection screen 52 in FIG. 4B. Thus, the individual display object parts store corresponding actions in advance, so that corresponding actions are assigned by the action setting section 253.

The process from S5 to S7 is executed for the individual display object parts until the user assigns and arranges display-object-part buttons to be displayed in the default screen 570 of the PC 31, and clicks an “OK” button 58 in the customization acceptance screen 54 with a mouse or the like, so that an instruction to terminate the designation and the placement is input by the user (S8).

After the designation and the placement of the display object parts by the user are completed (S8: YES), the generating section 254 generates screen data having a description determined by the designation of display object parts, layout instruction, and action setting in the script file format (S9). The screen data in the script file format is stored in the script-file storage unit 22 by the panel creator 250 (S10).

Then, the panel simulator 26 reads the script-file screen data and analyzes the description, converts the data to HTML-format data to enable the data to be displayed on the display of the PC 31, and causes the data to be displayed on the display so that the user can review it.

The following process may be performed as the process in S5 of FIG. 3.

If it is determined by the user authentication unit 200 of the server computer SV2 that the user is an authenticated user, and the user authentication section 27 of the PC 31 receives the result of the authentication from the server computer SV2 (S4: YES) and permits the user to start the display-screen generating process, the parts-designation accepting section 251 may limit selectable display object parts and the type of display screen depending on the user IDs of individual users.

That is, the parts-designation accepting section 251 has a table in which user IDs, display object parts permitted for the individual user IDs, and a display screen (default screen) are stored. The parts-designation accepting section 251 reads a display object part permitted for the ID of the authenticated user and the display screen from the table and causes a customization acceptance screen on which the read display object parts and the display screen (default screen) can be set to appear on the display (S5).

Thus, the description of the display screen that can be customized can be adjusted for individual users that ask for permission for the display-screen generating process, and as a result, functions executable by the multifunctional peripheral device 1 can be limited for the individual users.

The display-screen generating process by the panel creator 250 of the PC 31 is not limited to the above, and the process shown in FIG. 6 may be performed. FIG. 6 is a flowchart showing a display-screen generating process by the panel creator 250 according to a second embodiment. Descriptions of the same process as that of the first embodiment shown in FIG. 3 will be omitted.

In the second embodiment, in the case where the user performs the display-screen generating process, when an input of an instruction to create a display screen by the user is accepted by the parts-designation accepting section 251, the panel creator 250 is started, and the parts-designation accepting section 251 of the panel creator 250 causes the customization acceptance screen 54 to be displayed on the display of the PC 31 (S101).

That is, in the second embodiment, the panel creator 250 begins to initiate the display-screen generating process without performing the user authentication, as in the display-screen generating process of the first embodiment.

In the second embodiment, user authentication (through communication with the server computer SV2) is performed by the user authentication section 27 of the PC 31 after the user inputs an instruction to terminate the designation and placement. In such a case, the designation and placement of the display object parts by the user are terminated (S104: YES), and generation of the script file of screen data having description determined by the designation of display object parts, layout instruction, and action setting by the generating section 254 (S105) is completed (S106 to S108).

That is, the second embodiment performs the processes up to the generating process by the generating section 254 without performing user authentication, and if it is determined by the user authentication section 27 that the user is an authenticated user (S108: YES), the script-file screen data is stored in the script-file storage unit 22 by the panel creator 250 (S109).

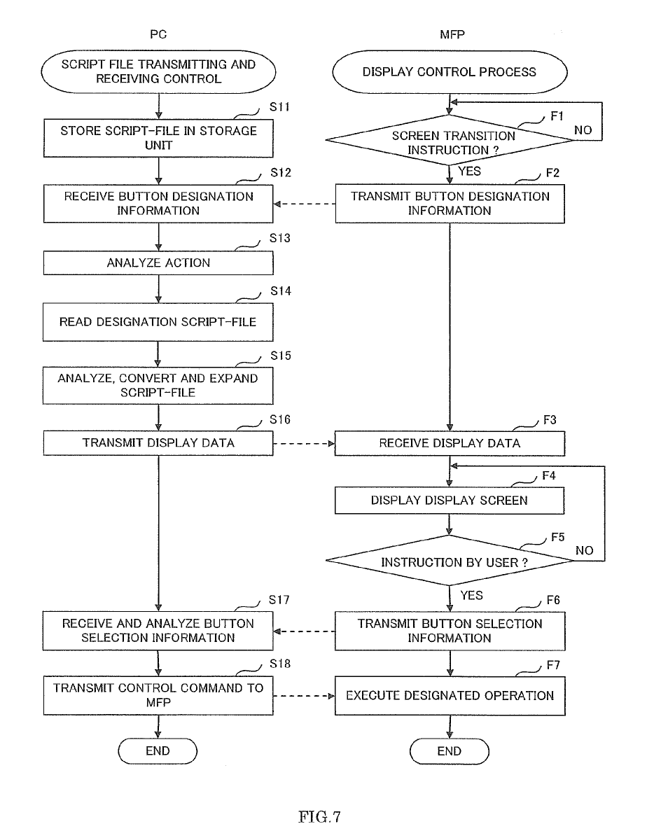

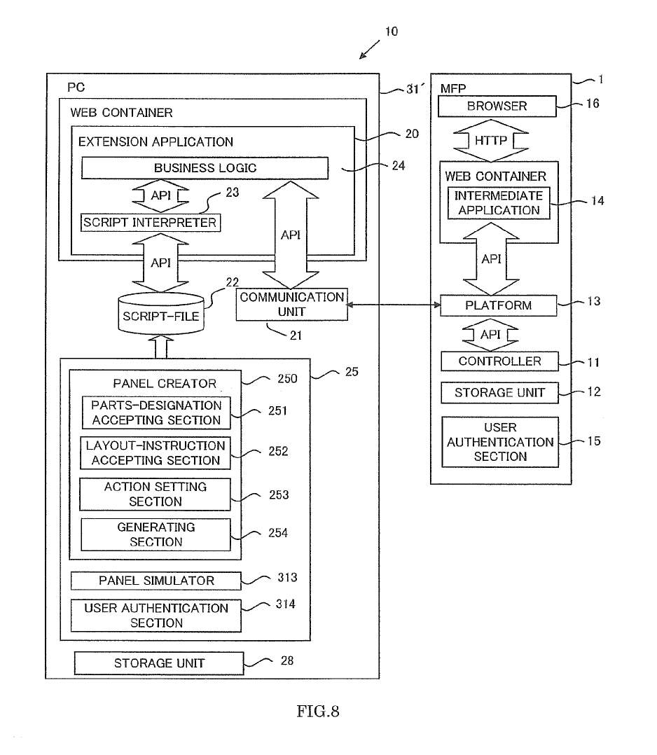

Next, a process of displaying a display screen generated by the PC 31 on the display 50 of the multifunctional peripheral device 1 and execution control of the operation of the multifunctional peripheral device 1 according to an instruction of the user to execute the operation thereof will be described. FIG. 7 is a flowchart showing the process of displaying a display screen generated by the PC 31 on the display 50 of the multifunctional peripheral device 1 and the execution control of the operation of the multifunctional peripheral device 1 according to a user instruction to execute the operation thereof.

When screen data is generated in the PC 31 in a series of processes shown in FIG. 3, the script-file screen data is stored in the script-file storage unit 22 in the PC 31 (S11).

Here, in the multifunctional peripheral device 1, a user instruction to shift the screen is input to the browser 16 via the operating device (not shown) (F1: YES), and the controller 11 makes an inquiry to the extension application 20 of the PC 31 via the platform 13 etc. (F2). Thus, the display process in the PC 31 using the screen data is performed as an action based on a user operation when a screen transition process is performed. The screen transition instruction includes an instruction to start the multifunctional peripheral device 1, which is input to the browser 16 when the power switch of the multifunctional peripheral device 1 is turned on. Control of the screen transition also includes display control for causing a start screen to appear on the display 50 in a non-display state.

For example, if the user depresses the “detail” button 522 using a touch panel function or the like when the controller 11 causes the workflow screen 52 to appear on the display 50 (see FIG. 4B), controller 11 makes an inquiry (i.e. sends a request for transmitting screen data to be displayed next) to the extension application 20 of the PC 31 via the platform, etc. That is, the controller 11 transmits button designation information indicating that the “detail” button 522 is designated by the user to the extension application 20 of the PC 31 via the platform 13, etc. (F2).

In the PC 31, when the communication unit 21 receives the button designation information (S12), the business logic 24 analyzes an action set for a button indicated by the button designation information (here, the “detail” button 522) (S13). Assuming that the analyzed action is a display screen control to shift to a specific display screen, the script interpreter 23 reads, from the script-file storage unit 22, the screen data (script file) of the specific display screen serving as a display screen shifted from the display screen displayed on the display 50 (S14), analyzes the read screen data, and performs an HTML conversion process for displaying the display screen on the display 50. The script interpreter 23 further performs a process of expanding the data to the business logic 24 for executing actions associated with the display object parts, such as operation buttons, placed in the display screen (S15).

That is, the script interpreter 23 performs the data conversion process for converting the read screen data to a data format (in this embodiment, the HTML format) that allows the screen data to be displayed on the display 50 using the browser 16 of the multifunctional peripheral device 1. Furthermore, the script interpreter 23 performs the process of expanding the data to the business logic 24 for executing actions associated with display object parts, such as an operation button, placed in the display screen to constitute the display screen indicated by the script file.

Next, the business logic 24 transmits the HTML-formatted data converted by the script interpreter 23 to the platform 13 of the multifunctional peripheral device 1 via the communication unit 21 as display data that can be displayed on the display 50 (S16).

In the multifunctional peripheral device 1, when the platform 13 receives the display data (F3), the browser 16 causes the received display data to be displayed on the display 50 (F4). Thus, the display screen generated by the panel creator 250 of the PC 31 (for example, the detail setting screen 53 shown in FIG. 4C) is displayed on the display 50 as a display screen shifted from the previous display screen displayed on the display 50. In this respect, the browser 16 functions as a display control unit.

For example, when any of the display buttons in the detail setting screen 53 shown in FIG. 4C is depressed (F5: YES) by the user using a touch panel function while the display screen is displayed by the browser 16, button designation information indicating the depressed display button is transmitted from the browser 16 to the business logic 24 of the PC 31 via the platform 13, the communication unit 21, etc. (F6). The display process of the PC 31 using the screen data is performed, for example, as an action based on the operation of the user when a screen transition process is performed.

In the PC 31, the business logic 24 analyzes an action associated with the display button indicated by the button designation information on the basis of the information passed from the script interpreter 23 (e.g. information about an action set for the display button indicated by the button designation information) (S17). For example, when a “600×600 dpi” button 531 of the detail setting screen 53 is depressed by the user, the business logic 24 determines, on the basis of the information passed from the script interpreter 23, that a functional operation corresponding to the “600×600 dpi” button 531 is the input of an instruction to execute the operation of causing the scanner unit to read the document at a resolution of 600×600 dpi at scanning.

Subsequently, to execute the analyzed function, the business logic 24 calls an API (control command) corresponding to the analyzed function and transmits the API to the controller 11 of the multifunctional peripheral device 1 via the communication unit 21, the platform 13, etc. (S18). For example, when the “600×600 dpi” button 531 is depressed by the user while the detail setting screen 53 is displayed, the business logic 24 determines on the basis of the information passed from the script interpreter 23 that a functional operation corresponding to the “600×600 dpi” button 531 is the input of an instruction to execute the operation of causing the scanner unit to read the document at a resolution of 600×600 dpi at scanning and accepts “the input of an instruction to execute the operation of causing the scanner unit to read the document at a resolution of 600×600 dpi”. Then, the business logic 24 calls an API corresponding to “the operation of causing the scanner unit to read the document at a resolution of 600×600 dpi” to execute “the operation of causing the scanner unit to read the document at a resolution of 600×600 dpi”.

The controller 11 of the multifunctional peripheral device 1 receives the API via the platform 13 and executes the indicated operation according to the received API (F7). For example, the controller 11 executes “the operation of causing the scanner unit to read the document at a resolution of 600×600 dpi”. That is, the business logic 24 sets the controller 11 via the API so that the scanner unit reads the document at a resolution of 600×600 dpi.

If the action analyzed in S17 is a display screen transition, the same processes as in S13 to S16 and F3 to F5 are performed.

The present invention is not limited to the configurations of the above embodiments, and various modifications can be made. For example, the above embodiments show examples in which the PC 31 includes the control unit 25, the storage unit 28, and the extension application 20; however, the present invention is not limited thereto but may have a configuration in which the PC 31 includes the control unit 25, and the multifunctional peripheral device 1 includes the storage unit 28 and the extension application 20.

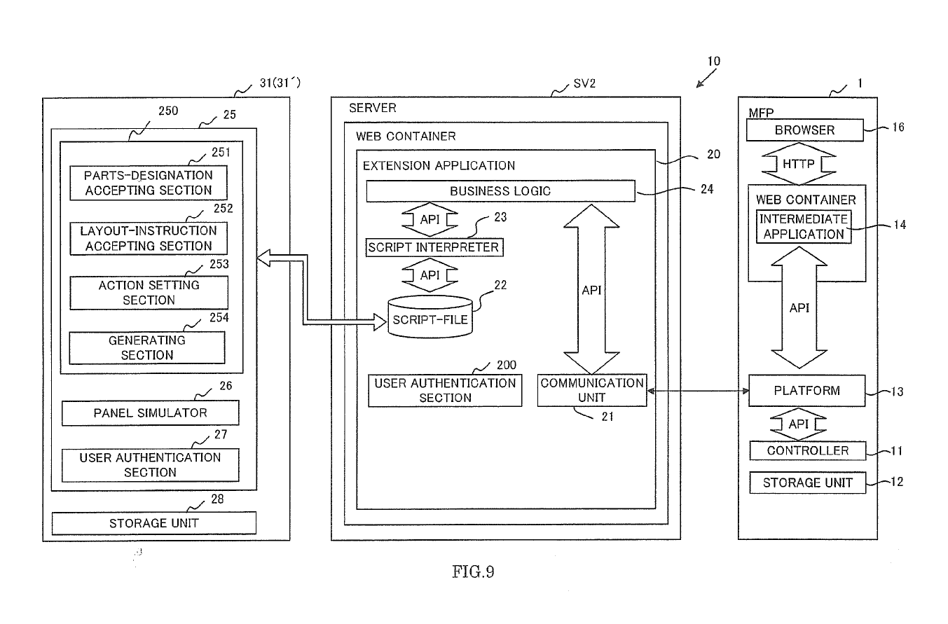

In the above embodiments, the user authentication section 27 of the PC 31 communicates with the server computer SV2 and determines whether the user who inputted the user identification information is an authenticated user according to the result of authentication by the server computer SV2. Instead, as shown in FIG. 8, the multifunctional peripheral device 1 may have a user authentication unit 15, and the user authentication may be performed using local authentication of the multifunctional peripheral device 1. In this case, a user authentication unit 314 of a PC 31′ communicates with the multifunctional peripheral device 1 and determines whether the user who inputted user identification information is an authenticated user according to the result of the authentication by the user authentication unit 15 of the multifunctional peripheral device 1.

That is, the user authentication unit 314 of the PC 31′ transmits user identification information input by the user to the multifunctional peripheral device 1 to inquire whether the user who inputted the user identification information is an authenticated user.

If the result of the authentication received from the user authentication unit 15 of the multifunctional peripheral device 1 shows that the user is an authenticated user, the user authentication unit 314 of the PC 31′ may permit a display-screen generating process, or the parts-designation accepting section 251 may limit selectable display object parts or the kind of display screen depending on the user IDs of individual users, as described above. Furthermore, for example, the parts-designation accepting section 251 may limit available functions (for example, Scan to SMB, Scan to FTP, and Scan to USM) depending on the user IDs of authenticated users.

Yet another embodiment will be described below. In the embodiments shown in FIGS. 2 and 8, the control unit 25, the storage unit 28, and the extension application 20 are provided in the PC 31 or 31′; however, the present invention is not limited thereto. As shown in FIG. 9, the control unit 25 and the user authentication section 27 may be provided in the PC 31 (or 31′), and the storage unit 22 and the extension application 20 may be provided in the server computer SV2, so that screen data generated by the panel creator 250 of the PC 31 (or 31′) may be converted into display data by the extension application 20 of the server computer SV2.

In the above embodiments, a display screen generated by the PC 31 or 31′ is displayed in the multifunctional peripheral device 1; however, the generated display screen is displayed not only in the multifunctional peripheral device 1 but also in the display of another electrical apparatus.

According to the embodiments of the present invention, the user authentication unit permits an authenticated user to generate the screen data of a display screen to be displayed on the display of an image forming apparatus or an electrical apparatus. This allows for effective management of permission for a user to customize a display screen.

According to the embodiments, for a display control to freely display a display screen in which the user customizes operation buttons, etc., as desired on the display of an image forming apparatus or an electrical apparatus, all the screen data of the display screen customized by the user might not held in the image forming apparatus or the electrical apparatus.

According to the above embodiments, there is no need for electrical apparatuses, such as an image forming apparatus, to convert the screen data of a display screen in a data format that is displayable on the display. Therefore, storing the screen data of a display screen customized by the user in the server allows the customized display screen to be displayed on the display of an electrical apparatus, such as an image forming apparatus, without performing an operation such as registering the screen data in the electrical apparatus.

This can increase the extensibility of the display control of displaying a plurality of display screens on the display of an electrical apparatus, such as an image forming apparatus.

According to the embodiments, presentation of display object parts by a display-object-parts presenting section is permitted by the user authentication unit when the user is an authenticated user. Therefore, if the user is not an authenticated user, the user is not permitted to start the operation of generating the screen data of display screens. Therefore, according to the above embodiments, customization by the user who wishes to create the screen data of a display screen can be prevented at an early stage before the user starts the customization of the display screen.

According to the embodiments, when the display-object-parts presenting section is set so as to present different display object parts depending on individual users, the description of the display screen that can be customized can be controlled according to the individual users. As a result, actions that can be executed in the image forming apparatus (the functions of the image forming apparatus) can be limited with descriptions according to the individual users.

According to the embodiments, processes to the end of generation of screen data by the generating section are permitted by the user authentication unit irrespective of whether the user is an authenticated user, and if the user is not an authenticated user, storage of the generated screen data into the storage unit is not permitted. Therefore, according to the embodiments, customization by the user who wishes to create the screen data of a display screen can be prevented after the user starts customizing the display screen.

According to the embodiments, even if the user's information processing apparatus does not have the information and processing program necessary for user authentication, user authentication necessary for determining permission to generate screen data according to the user still can be performed. Therefore, for example, if an employee ID card such as RFID (Radio Frequency Identification) card or the like in which the stored user ID is read using a card reader of the information processing apparatus, the user authentication unit can determine whether to permit the user to perform the screen data generating process using the result of authentication by a server that manages the user ID.

According to the embodiments, even if the user's information processing apparatus does not have the information and processing program necessary for user authentication, user authentication necessary for determining permission to generate screen data according to the user still can be performed. Therefore, for example, in a case where the image forming apparatus has a user authentication function based on an input user ID, the user authentication unit can determine whether to permit the user to perform the screen data generating process using the result of authentication by the image forming apparatus.

It is to be understood that the scope of the present invention is not limited to the above embodiments and that various modifications can be made without departing from the spirit of the invention. Although the configurations and the processes of the embodiments of the invention are shown in FIGS. 1 to 9, the illustrated configurations and the processes are merely examples of embodiments of the invention.

What is claimed is:

1. An information processing apparatus configured to be connected to an image forming apparatus, comprising:
a user authentication unit configured to permit a user who inputted identification information, if the user is an authenticated user, to create screen data of a display screen to be displayed on a display of the image forming apparatus;
a display-object-parts presenting section configured to present display object parts to be displayed in the display screen;
a parts-selection-instruction accepting section configured to accept, from the authenticated user, a display-object-parts selection instruction to select display object parts from the display object parts presented by the display-object-parts presenting section;
a layout-instruction accepting section configured to accept, from the authenticated user, a layout instruction to place the selected display object parts in the display screen;
an action setting section configured to set actions corresponding to display object parts indicated by the display-object-parts selection instruction accepted by the parts-selection-instruction accepting section in association with the display object parts; and
a generating section configured to generate the screen data of the display screen on the basis of the display-object-parts selection instruction, the layout instruction, and the setting by the action setting section.

2. The information processing apparatus according to claim 1, further comprising:
a storage unit configured to store the screen data of the display screen generated by the generating section;
a data converting section configured to generate display data by reading the screen data from the storage unit, analyzing the screen data, and converting the screen data to a data format that is displayable on the display; and
a screen-data transmitting section configured to transmit the display data generated by the data converting section to the image forming apparatus.

3. The information processing apparatus according to claim 1, wherein if the user who inputted the identification information is not an authenticated user, the user authentication unit does not permit the display-object-parts presenting section to present display object parts.

4. The information processing apparatus according to claim 3, wherein the display-object-parts presenting section presents the display object parts limited according to the authenticated user authenticated by the user authentication unit.

5. The information processing apparatus according to claim 1, wherein if the user who inputted the identification information is not an authenticated user, the user authentication unit does not permit the screen data generated by the generating section to be stored in the storage unit.

6. The information processing apparatus according to claim 1, wherein the user authentication unit determines whether the user who inputted the identification information is an authenticated user by transmitting the inputted identification information to a server connected to the information processing apparatus via a network and obtaining, from the server, the result of authentication performed by the server on the basis of the identification information.

7. The information processing apparatus according to claim 1, wherein the user authentication unit determines whether the user who inputted the identification information is an authenticated user by transmitting the inputted identification information to the image forming apparatus and obtaining, from the image forming apparatus, the result of authentication performed by the image forming apparatus on the basis of the identification information.

8. The information processing apparatus according to claim 1, wherein the generating section generates the screen data of the display screen in a markup language.

9. The information processing apparatus according to claim 8, wherein the generating section generates the screen data of the display screen in a script file format.

10. The information processing apparatus according to claim 8, wherein the generating section generates the screen data of the display screen in an extensible markup language format.

11. The information processing apparatus according to claim 2, wherein the data converting section generates the display data in a hypertext markup language format.

12. An image forming system including an information processing apparatus and an image forming apparatus, wherein
the image forming apparatus comprises a display; and
the information processing apparatus comprises:
a user authentication unit configured to permit a user who inputted identification information, if the user is an authenticated user, to create screen data of a display screen to be displayed on the display of the image forming apparatus;
a display-object-parts presenting section configured to present display object parts to be displayed in the display screen;
a parts-selection-instruction accepting section configured to accept, from the authenticated user, a display-object-parts selection instruction to select display object parts from the display object parts presented by the display-object-parts presenting section;
a layout-instruction accepting section configured to accept, from the authenticated user, a layout instruction to place the selected display object parts in the display screen;
an action setting section configured to set actions corresponding to display object parts indicated by the display-object-parts selection instruction accepted by the parts-selection-instruction accepting section in association with the display object parts; and
a generating section configured to generate the screen data of the display screen on the basis of the display-object-parts selection instruction, the layout instruction, and the setting by the action setting section.

13. A method for customizing a display screen on an image forming apparatus, comprising:
determining whether a user is authenticated based on identification information inputted by the user through an input device associated with a computer connected through a network to the image forming apparatus;
upon determining that the user is an authenticated user, permitting the user to create screen data of a display screen to be displayed on a display of the image forming apparatus;
presenting display object parts to be displayed in the display screen;
accepting, from the authenticated user, a display-object-parts selection instruction to select display object parts from the presented display object parts;
accepting, from the authenticated user, a layout instruction to place the selected display object parts in the display screen;
setting actions corresponding to accepted display object parts; and
generating the screen data of the display screen on the basis of the display-object-parts selection instruction, the layout instruction, and the action setting.
